(19) United States
(12) Patent Application Publication
(10) Pub. No.: US 2016/0148539 A1
(43) Pub. Date: May 26, 2016

(54) DRY POWDER INHALER RESPIRATORY TRAINING DEVICE AND SYSTEM

(71) Applicants: Jeff Baker, Orlando, FL (US); Francis Michael Siemer, Orlando, FL (US); Matthew Palyo, Orlando, FL (US); Seth Freytag, Winter Springs, FL (US); Christopher Chung, Orlando, FL (US); Kristin DeSanto, Winter Garden, FL (US); Paul van der Pol, Winter Garden, FL (US)

(72) Inventors: Jeff Baker, Orlando, FL (US); Francis Michael Siemer, Orlando, FL (US); Matthew Palyo, Orlando, FL (US); Seth Freytag, Winter Springs, FL (US); Christopher Chung, Orlando, FL (US); Kristin DeSanto, Winter Garden, FL (US); Paul van der Pol, Winter Garden, FL (US)

(21) Appl. No.: 14/551,573

(22) Filed: Nov. 24, 2014

(51) Int. Cl. G09B 23/28

(52) U.S. Cl. CPC G09B 23/28

(57) ABSTRACT

Embodiments of a respiratory inhaler training device to provide stepwise instructions for using the device to a user in a sequence of steps are provided herein. The respiratory inhaler training device may include a housing defining a channel with an inlet and an outlet, at least one actuation mechanism simulating provision of medicament, at least one fluid flow rate sensor positioned so as to detect fluid flow in the channel, a signal output component for providing an output to the user, a microprocessor comprising a timekeeping component, a storage medium component associated with the microprocessor comprising a database of instructions pertaining to the sequence and/or timing of steps for using the device stored thereon, one or more program code modules stored on the microprocessor or the storage medium component, or a combination thereof, wherein the one or more program code modules include a first program code module for causing the microprocessor to provide a first instruction, and a second program code module for causing the microprocessor to provide a subsequent instruction based on a current register.

### BACKGROUND

Respiratory inhalation devices are used to treat a number of different diseases and conditions, or to relieve symptoms associated therewith including asthma, chronic obstructive pulmonary disease (COPD), cystic fibrosis, among other illnesses. Use of respiratory inhaler devices can be complex and oftentimes difficult, as each type of device and/or each medication includes its own Instructions for Use (IFU). Some medications have numerous steps which must be followed in a precise manner in order to receive an accurate dosage of the medication. Moreover, some respiratory inhalation devices and medication require precise timing of multiple steps to be performed in conjunction with one another. Without proper training, these devices can be extremely difficult to use and can create a sense of anxiety in a user.

Self-management of chronic conditions can be complex and self-medication can often result in an unpleasant and/or ineffective experience. Experiences of patients that are new to medicament delivery devices include anxiety, errors, and non-compliance. Medicaments that are administered at home with devices account for over 200,000 adverse events in the Food and Drug Administration (FDA) Adverse Event Reporting System (AERS) database. The FDA considers patient errors as device failures. Consequently, the FDA is attentive and oftentimes critical of self-management devices. Device developers therefore, focus on ease of use of the device in development, but do not focus much attention to the ease of learning, which is the most relevant and most critical factor in reducing patient errors.

Chronic Obstructive Pulmonary Disease (COPD) is a progressive, lifelong disease characterized by poor airflow and lung performance. Symptoms of COPD include coughing, shortness of breath, fatigue, frequent respiratory infections and wheezing. There are two main forms of COPD, chronic bronchitis is a disease in which the bronchi develop chronic inflammation and swelling due to the irregular growth of mucus glands and over time, progressive damage is caused to the intracellular walls of effected airways. Chronic bronchitis is the most common form of COPD, affecting approximately 12 million people in the USA. A second form of COPD is emphysema, wherein alveolar membranes deteriorate, reducing the surface area of the lung. Over time, emphysema reduces the elasticity and support of airways, leading to further complications such as collapsed lung and respiratory failure.

The primary cause of COPD is smoking. Secondary causes include air pollution, occupational exposures and genetics. COPD is currently the third leading cause of deaths in the United States (approximately 134,000 deaths annually). In the United States, there are approximately 13 million diagnosed cases of COPD and 24 million adults living with lung impairments, and there is currently no cure for COPD.

Cystic Fibrosis (CF) is an incurable chronic disease that affects the glands that produce mucus and sweat. A defective gene causes the body to produce unusually thick, sticky mucus that affects the lungs and digestive system. As the mucus builds up, it blocks airways in the lungs, which makes it increasingly difficult to breathe. Mucus buildup also encourages the growth of bacteria, which cause life-threatening lung infections. Mucus buildup also obstructs the pancreas from producing essential digestive enzymes. The intestines need these enzymes to process the nutrients in food, such as vitamins and minerals. People with CF also lose large amounts of salt when they sweat. This can cause an unhealthy imbalance of minerals in the blood. CF is one of the most common chronic lung diseases in children and young adults. About 30,000 children and adults in the United States (70,000 worldwide) have CF. Approximately 1,000 new cases of cystic fibrosis are diagnosed each year in the USA. More than 70% of patients are diagnosed with CF by age two. More than 45% of the CF patient population is age 18 or older.

Multi-sensory learning is very important for effectively learning new behaviors, particularly when there are multiple steps and requirements that must be met, such as with the use of self-medication devices. Additionally, it is critically important that these devices be used correctly to assure compliance and effective administration of medicaments to patents in need. Triggered by sensory stimulation, the brain constantly creates new network connections between neurons. Each time we learn, the new connections slightly change the brain. Multisensory learning is based on several neurophysiological and psychological principles, including i) the human body has approximately 20 sensory systems, the sensory stimuli most relevant to learning are auditory, visual, somatosensory (tactile), gustatory, and olfactory; ii) multisensory learning engages multiple sensory modalities, which are interpreted in distinct areas of the brain; iii) sensory stimuli are integrated in the superior colliculus, the structure of the superior colliculus, located in the midbrain, contains a high proportion of multisensory neurons; iv) the more senses are stimulated, the more network pathways are available for retrieval, thus, the better we learn. This is as long as each sense gets a signal at the same time, space and meaning; v) it is autonomous and ubiquitous, the brain is already wired for it and there are many instances of multisensory learning in everyday life; and vi) not only do the senses complement one another, they can modulate (strengthen) one another. This mutual reinforcement facilitates processing and retention in the brain.

There are numerous benefits of multisensory learning, some of which include: a) under the right conditions, information is processed and interpreted faster; b) better retention in memory and information is remembered over a longer period of time; c) distraction is avoided -if a sense (eye, ear, etc.) is not in use for learning, it will still be active, and if it receives a signal that is not in agreement with the subject matter, it all aspects of learning are interrupted; d) with multiple senses occupied, is easier to hold attention; e) a single sensory cue activates all areas of the brain that have received stimuli (cross-modal processing), this phenomenon is the most surprising and powerful discovery of the use of magnetic resonance imaging (MRI) in neuroscience, for example; and f) people who have entrenched neural pathways (older people), multisensory learning is especially helpful in the acquisition of new knowledge that is contradictory to prior experience.

To take advantage of the neurological mechanisms in the brain, certain requirements need to be considered in regard to medicament training devices. The requirements for multisensory learning are: spatially, the sources of stimuli have to be in close proximity; temporally, the sources of stimuli have to be synchronous; semantically, the stimuli have to be congruous (see above); minimize sensory redundant information (both within mode and in between mode), otherwise, a split in attention will result. Additionally, active learning induces greater multisensory integration compared to passive observation. Active motor learning, where the learner engages in the real thing, modulates the establishment and processing of multisensory connections. Functional connectivity between visual and motor cortices is stronger after active learning than passive learning.

A four stage process occurs with educating a new patient to use an unfamiliar medicament delivery device. The first stage includes the training of sales representatives of a pharmaceutical company wherein the company has extensive control over the consistency of the training message. In the second step, the sales representative trains the healthcare provider (HCP). Because both the sales representatives and healthcare providers are often stressed for time, and due to the enormous variance in training environments, message erosion can occur. The healthcare provider then trains the patient. Typically, such a training session takes 30 minutes, a significant amount of time in a healthcare provider's day, and an amount of time the healthcare provider is reluctant to give up. Because of the enormous variance in educational backgrounds and teaching experience of healthcare providers, significant message erosion is takes place in this four stage process. Lastly, the fourth step includes the patient who learns how to use the device and practices repeatedly with the device at home.

Dry Powder Inhaler devices (DPI) are used to deliver medicament to patients affected with certain medical conditions. Misuse of these devices can result in patients obtaining an incorrect dose of medicament or no medicament at all. Additionally, misuse of the device may result in destruction of the device. Furthermore, these devices may cause anxiety in patients who use them, due to the number of steps and particular order within which they must be completed, for example. A DPI delivers medication through the lungs without any chemical propellant. The medication in a DPI is contained within capsules or blisters in a powdered form. The DPI requires a user to inhale at a certain rate in order to receive the medication contained within the capsules deep into the lungs of the user. Proper inhalation rate is critical to using a DPI correctly and receiving an accurate dose of medicament. The most common errors associated with the use of DPI's include: 1) failing to pierce the capsule or blister; 2) failing to inhale strongly enough; 3) failing to inhale for a sufficient time period; 4) failing to properly orient the inhaler during preparation; and 5) exhaling or breathing into the device, which would introduce moisture to the dry powder.

### SUMMARY

In one embodiment, a respiratory inhaler training device to provide stepwise instructions for using the device to a user in a sequence of steps is provided. The respiratory inhaler training device may include a housing defining a channel with an inlet and an outlet, at least one actuation mechanism simulating provision of medicament, at least one fluid flow rate sensor positioned so as to detect fluid flow rate in the channel, a signal output component for providing an output to the user, a microprocessor comprising a timekeeping component, a storage medium component associated with the microprocessor comprising a database of instructions pertaining to the sequence and/or timing of steps for using the device stored thereon, one or more program code modules stored on the microprocessor or the storage medium component, or a combination thereof, wherein the one or more program code modules include a first program code module for causing the microprocessor to provide a first instruction, and a second program code module for causing the microprocessor to provide a subsequent instruction based on a current register.

In another embodiment, a respiratory inhaler training system configured to provide instructions for using a respiratory inhaler training device to a user in a sequence of steps is provided. The system may include a respiratory inhaler training device having a housing defining a channel with an inlet and an outlet, the respiratory inhaler training device including an actuation mechanism, said actuation mechanism configured to simulate provision of medicament. The system may further include a respiratory inhaler training container, wherein the training device communicatingly connects to the respiratory inhaler training container. A signal output component may be associated with the respiratory inhaler training container and a microprocessor may be associated with the respiratory inhaler training device or container configured so as to control a provision of the instructions to the user in the sequence of steps.

In a further embodiment, a respiratory inhaler training device configured to provide stepwise instructions for using the device to a user in a sequence of steps is provided. The respiratory inhaler training device may include a housing defining a channel with an inlet and an outlet, at least one actuation mechanism for simulating provision of medicament, at least one fluid flow rate sensor positioned so as to detect fluid in the channel, at least one contact sensor disposed between the housing and the actuation mechanism to detect activation and/or deactivation of the actuation mechanism; at least one signal output component for providing an output to the user, and a microprocessor including a timekeeping component, in a non-limiting embodiment, said timekeeping component may be configured to measure elapsed time during and/or between the sequence of steps. The training device may further include a storage medium component associated with the microprocessor comprising a database of instructions pertaining to the sequence of steps for using the device stored thereon, one or more program code modules stored on the microprocessor or the storage medium component or a combination thereof, wherein the one or more program code modules comprise a first program code module for causing the microprocessor to provide a first instruction; and a second program code module for causing the microprocessor to provide a subsequent instruction based on a current register, wherein based on a signal received from the at least one fluid flow rate sensor, at least one contact sensor, and/or at least one orientation sensor, and/or an input received from the user, the microprocessor detects a condition of the device.

### BRIEF DESCRIPTION OF DRAWINGS

FIG. 1 includes a perspective view of an embodiment of a respiratory inhaler training device.

FIG. 2 is a sectional view of the embodiment of the respiratory inhaler training device taken along line X-X in FIG. 1.

FIG. 3 is a side elevational view of an embodiment of a respiratory inhaler training device.

FIG. 4. is a cross sectional view of the embodiment of the training device taken along line Y-Y of FIG. 3.

FIG. 5 is a table showing ranges of values for conditions in an embodiment of the training device.

FIG. 6 is a flow chart providing an embodiment of a logic for an embodiment of the training device.

FIG. 7 is a flow chart providing an embodiment of a logic for an embodiment of the training device.

FIG. 8 is a flow chart providing an embodiment of a logic for an embodiment of the training device.

FIG. 9 is a flow chart providing an embodiment of a logic for an embodiment of the training device.

FIG. 10 is a flow chart providing an embodiment of a logic for an embodiment of the training device.

FIG. 11 is a flow chart providing an embodiment of a logic for an embodiment of the training device.

FIG. 12 is a flow chart providing an embodiment of a logic for an embodiment of the training device.

FIG. 13 is a flow chart providing an embodiment of a logic for an embodiment of the training device.

FIG. 14 is a flow chart providing an embodiment of a logic for an embodiment of the training device.

FIG. 15 is a table including an embodiment of a sequence of steps and a sequence of messages provided at each step.

FIGS. 16a-d are graphical representations of various examples of inhalation flow rates.

FIGS. 17a-d are graphical representations of various examples of inhalation flow rates.

FIG. 18 provides an embodiment of a respiratory inhaler training system.

### DETAILED DESCRIPTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

At a low air flow rate, the air flow is laminar, where at a higher air flow rate, the air flow becomes turbulent. The use of a dry powder respiratory inhaler requires sufficient air turbulence to receive a proper dosage of a medicament. Practice using a respiratory inhaler training device and/or system can assist a patient in establishing autonomous time and/or motor skills of what sufficient air flow rate feels like. Only frequent use of the respiratory inhaler training device and/or system can improve timing and provide a user with the tools to develop the technique to use the inhaler medicament delivery device to receive a required dose of medicament. Benefits of the respiratory training device embodiments described herein include familiarizing patients with the training device, which closely resembles the medicament delivery device on the market so as to increase patient confidence and comfort in using the device. This will assist in reducing patient error in using the device, allow a user to develop autonomous motor skills and reduce the amount of time of and reduce the burden on health care providers to assist and train patients to use the device. Furthermore, respiratory training devices will provide benefits including reducing error rate when using the drug delivery inhaler device, as well as increase patient comfort and confidence in using the drug delivery inhaler device.

Two primary environments for training a user to use a respiratory inhaler medicament delivery device with the use of the respiratory inhaler training device includes: in a healthcare provider's office or other healthcare setting in which a physician or a nurse most likely educates themselves on how to use the respiratory inhaler training device. The healthcare provider will then use the training device to train the patient in a typical exam room setting that includes chairs and a countertop, but no table, in one example. The second setting is an at home setting, wherein the patient will practice with the training device at home, either alone or with, in most instances, a non-medically trained companion. The training device can be used without medical supervision before the first use of the medicament delivery respiratory inhaler device, in an embodiment. A refresher training with the training device may occur as needed just before the subsequent use of the medicament delivery respiratory inhaler device.

The Food and Drug Administration (FDA) mandates that all users of medical devices used in home healthcare have readable and understandable instructions in order to operate these devices safely and effectively. The instructions for use of various medical inhaler device describe numerous steps the patient has to take to safely administer a full dose of medication using the device. It is important for the patient to read the IFU in addition to using the training device to assist the user in learning to correctly use and increase comfort in using the medicament delivery device. The sequence of steps in the instructions for using the device are critically important, therefore, the training device may follow the instructions for use sequence in an embodiment.

Embodiments of a training device provided herein for use as a respiratory inhaler training device provide an ability to identify mistakes in the use of a respiratory inhaler delivery device before the medicament delivery device is used by a patient, increase compliance in proper use of the medicament delivery device, improve adequacy of use of the medicament delivery device, identify errors patients make with the device, intervene where a patient makes a mistake, and guide the patient through proper use of the device. Error recognition may occur through the use of sensors, including fluid flow rate and fluid direction sensors, orientation sensors, contact sensors, accelerometers, among other types of sensors that may be used. The device is able to teach a user the air flow rate required for proper medicament administration via a respiratory inhaler device. The device tracks the proper sequence of actions and precise timing of events and provides auditory and/or visual feedback to a user accordingly. The training experience allows a patient to establish muscle memory. Some of the tracked events include: 1) inhalation, wherein a fluid flow rate sensor is used to detect sufficient inhalation force, 2) activating the actuation mechanism, wherein a contact sensor is used, 3) measuring elapsed time, wherein a timekeeping component of the microprocessor is used, 4) providing a signal to prompt a user when to perform an action (i.e., activating the actuation mechanism), wherein an audio output is used such as a beeping sound, and 5) measuring inhalation volume, wherein the fluid flow rate sensor and timer are used.

Definitions:

A “predetermined value” as used herein, for example, includes but is not limited to a value or range of values relating to an event involving use or operation of the device. These may include, but are not limited to thresholds, ceilings, baselines or range values that are desired or undesired for a particular event. Examples of predetermined values include, but are not limited to, a predetermined orientation value, predetermined time value, or a predetermined contact value, in addition to other predetermined values described herein refers to a value that is used as a reference value in relation to a value, signal, or indication that is detected by, for example, a sensor of the delivery training device. Predetermined value may include an optimal value, or a sub-optimal value, or any value there between.

In one example, a predetermined orientation value may include a 90 degree angle between the device and a target region for the device, an additional predetermined orientation value may include a 10 degree angle between the device and a target region for the device. At either predetermined orientation value, or at any value there between, a signal output component may be initiated. The signal output component may therefore be an error message or a congratulatory message, for example.

The term “condition” as used herein includes but is not limited to a user input, a status of the device, anything that is sensed by the device, correct or incorrect stepwise activities, usage of the device over time, among other conditions. A condition may be detected based on one or more values received from the device or a sensor of the device.

The term “error condition” as used herein includes but is not limited to a condition pertaining to a mistake by the user in using the device, whether the mistake is incorrect positioning or contact between the device and the user, or whether the mistake is an out of order action, an action that exceeds or fails to meet predetermined time value (such as an undue pause during or between actions, or insufficient time for conducting an action or transition between actions). Error conditions may also include errors of the device itself, including low or lack of power or failure to operate as intended.

The term “timekeeping component” as used herein includes, but is not limited to, a component of the microprocessor for keeping time such as, for example, a clock or a timer.

The term “fluid” as used herein, includes but is not limited to air, liquid, gas, powder, or any other such substance as known in the art to be included by the term fluid. Note that a gas is considered a fluid of low density, therefore, any time the term “fluid” is used, the meaning is inclusive of the term “gas.”

The term “signal output component” as used herein includes, but is not limited to, a component which may provide an audible, visual, gustatory, olfactory, or tactile output. It includes speakers which provide audio output, mechanical components of a device which move with or against one another to produce either tactile output, visual output, or audio output (i.e., mechanical clicks) or a combination thereof. The signal output component may include one or more lights, displays, or videos. Multiple signal output components may be provided in or associated with one device or one system. Various signal output components can be used in conjunction with one another. Certain signal output components may provide multiple sensory stimulation or signals, such as a video tutorial providing instructions for use which provides both visual and audio feedback, stimulation and instruction to a user, for example. The signal output component can be provided for the benefit of a user to observe or to indicate information to the user of the system or device. The signal output component may also be detectable by a remote or external device, for example. In some non-limiting embodiments, the signal output components may produce a whistle or sound made as a result of inhalation through the respiratory training inhaler device by a user, for example. Therefore, the signal output component may refer to a particular orientation of the parts of the device such that inhalation through the device produces an audible output or parts of the device that move relative to one another to provide an output which can be received and/or analyzed either by a user or by a remote or external device, in non-limiting examples. This output, as aforementioned, may be visual, auditory, tactile, gustatory, olfactory, or any combination thereof. In some non-limiting examples, the output may include a light, a radio signal produced by a signal output component such as an emitter, or a vibratory output produced by a signal output component. The term “associated” or “association”, as used herein, includes but is not limited to direct and indirect attachment, adjacent to, in contact with, partially or fully attached to, and/or in close proximity therewith. The term “in conjunction with” as used herein includes but is not limited to synchronously or near synchronous timing, the phrase may also include the timing of outputs, where one output directly follows another output.

The term “medicament capsule(s)” as used herein may include capsules containing medicament in a powder form in a non-limiting embodiment, blisters that may contain medicament in a powder form and may be available as a blister roll, in a non-limiting example. Consequently, in instances herein in which the term “capsule” is used, it may refer to a capsule or a blister or any other type of vesicle for housing medicament or for training without medicament.

The term “value” as used herein, may refer to a specific value or a range of values.

The term “fluid flow rate” as used herein includes a rate of fluid movement through a forced inhalation or exhalation of a user over time as measured by a fluid flow rate sensor, in non-limiting embodiments. Fluid flow rate is measured as volume of fluid movement over time. In order to receive a proper dose of some medications, there is a required fluid flow rate over a specified time period that one must achieve while using a respiratory inhaler device. In some instances, as with dry powder inhaler medicament delivery devices, inhalation or inspiration must be between a predetermined rate range for a predetermined time period (e.g., between 40 L/min and 85 L/min for an accumulated time of at least 1.5 seconds) in order to receive a correct dose of medicament. While a single inhalation should be approximately one liter or more, in a non-limiting embodiment, as long as the abovementioned criteria is satisfied, a patient should receive a correct dose of medicament. If an inhalation goes both above and below the predetermined rate range, only the inspiratory volume within the predetermined rate range may be counted toward the total amount of time required for an inhalation of a medicament for example. For a device or a medicament that requires at least 40 L/min fluid flow rate, only the inspiratory volume at or above the 40 L/min is counted toward the 1.5 seconds of inhalation of medicament, in a non-limiting embodiment.

In one embodiment, the respiratory inhaler training device the one or more predetermined fluid flow rate values may include an upper limit and/or a lower limit. In a further embodiment of the device and/or system described herein, a first error message may be provided if a detected fluid flow rate value is higher than the upper limit, and a second error message may be provided if a detected fluid flow rate value is below the lower limit. The first error message may be different from the second error message. In one particular, non limiting embodiment, the upper limit may include 85 L/min and the lower limit may include 45 L/min.

The terms “subroutine” and “function” as used herein, should be considered synonyms.

These inspiratory requirements are important in achieving the best results with use of the inhaler, resulting in the medicament being delivered deep into the lungs of the user. If a user exceeds the predetermined rate range when using an inhaler training device for a dry powder inhaler, an error condition will occur as it is likely that the user will cough or choke from the powder of the medicament being inhaled into the airway of the user. This may prevent the medicament from reaching deep into the lungs of the user which is important for proper medicament administration of a dry powder medication. If a fluid flow rate is too low, the medicament will not be delivered deep into the lungs, and consequently an error condition of the respiratory inhaler training device will result.

In one embodiment, a respiratory inhaler training device to provide stepwise instructions for using the device to a user in a sequence of steps is provided. The respiratory inhaler training device may include a housing defining a channel with an inlet and an outlet, at least one actuation mechanism simulating provision of medicament, at least one fluid flow rate sensor positioned so as to detect fluid flow rate in the channel, a signal output component for providing an output to the user, a microprocessor comprising a timekeeping component, a storage medium component associated with the microprocessor comprising a database of instructions pertaining to the sequence and/or timing of actions for using the device stored thereon, one or more program code modules stored on the microprocessor or the storage medium component, or a combination thereof, wherein the one or more program code modules include a first program code module for causing the microprocessor to provide a first instruction, and a second program code module for causing the microprocessor to provide a subsequent instruction based on a current register.

In an embodiment, the respiratory inhaler training device may include multiple sensors to detect conditions of the device. The sensor may be disposed on or in the device or otherwise associated with the device. In one embodiment, the sensors may include a fluid flow rate sensor, a pressure sensor, an orientation or perpendicularity sensor, a contact sensor, a temperature sensor, or other type of sensor known to those of skill in the art to detect various elements with the device herein. In one particular embodiment, a fluid flow rate sensor may be provided in the channel of the device at or near the outlet of the device in some non-limiting embodiments. In another embodiment, the device may further include a fluid direction sensor configured to identify the direction of fluid flow rate in the channel. Based on the direction of fluid detected by the fluid direction sensor, information can be output to a user by way of a signal output component of the device. In some embodiments, the fluid flow rate and fluid direction may be detected by one sensor, namely, a thermal mass flow sensor, in a non-limiting embodiment. In other embodiments, the device will have both a fluid flow rate sensor and a fluid direction sensor, wherein the fluid flow rate sensor includes a pressure sensor, a turbine sensor, a differential pressure sensor, or a thermal mass flow sensor, or a combination thereof. In a further embodiment, the fluid flow rate sensor may include a hot wire, a leaf, an ultrasonic doppler, or coriolis, or a combination thereof. The fluid flow rate sensor may be removable in a non-limiting embodiment. In a further embodiment, the fluid flow rate may be determined with an embodiment of the device comprising a rotating shading plate, wherein the rotating plate rotates about an axis, and the rotation of the shading plate is caused by airflow in the device. One or more photoelectric sensors disposed near the shading plate may be provided to detect the speed at which the shading plate is rotating, such that airflow rate may be calculated as a result. In this non-limiting embodiment, the components of the device can be placed in the device such that the airflow channel can remain clear of components, reducing the risk of contaminating the electronics of the device. In a further embodiment, a magnetic (i.e., hall) sensor can be used instead of, or in addition to the photoelectric sensor.

In non-limiting embodiments provided herein, the device may detect airflow volume by testing the fan blade rotation rate and calculate the volume of airflow (photoelectric sensor, hall sensor testing the pressure made by the airflow to calculate the volume of airflow, or by testing the temperature change to calculate the volume of airflow.

In a further embodiment, the respiratory inhaler training device may be provided wherein the one or more predetermined fluid flow rate values comprise an upper limit fluid flow rate value and a lower limit fluid flow rate value. In still a further embodiment, a first error message is provided if a detected fluid flow rate value is higher than the upper limit fluid flow rate value, and a second error message is provided if a detected fluid flow rate value is lower than the lower limit fluid flow rate value. In yet a further embodiment, the first error message is different than the second error message.

The signal output component of the device may provide information or output to a user based on a condition of the device, an error condition (i.e., error message) of the device, a confirmation message or congratulatory message of the device, a message in response to an input initiated by the user of the device or any interruption of the device either by the user or generated by the device itself (i.e., by a signal received from a sensor, for example) in response to use of the device by the user in a non-limiting embodiment. In a further embodiment, an output of the device from the signal output component is initiated in response to a predetermined value detected for a condition.

The medicament device may further include at least one responsive member that is reactive to user input. The responsive member may include a button, either virtual or non-virtual, a switch, a touch sensor, a toggle, a heat or tactilely sensitive response sensor, or any combination thereof, or any other such device as known in the art. The responsive member may be part of the control interface of the device. Alternatively, or in addition to being disposed on the device, at least one responsive member can be in association with the device. The control interface can be used for generating user commands, and the microprocessor is in communication with the control interface. The microprocessor may be configured and arranged to receive input from the user via the control interface, wherein the processor-based circuit includes an audio signal processor configured and arranged to provide audio to the user to instruct the user while using the medicament device during the medicament delivery or simulation/training, wherein the audio is controlled by the responsive member on the control interface via user input.

In one embodiment the sensor may include an orientation sensor. The orientation sensor can detect the angle at which the device is held relative to another object (i.e., the user). An orientation sensor is typically implemented as a multi-axis MEMS gyroscope that measures inertia or angular rate, in some embodiments. An orientation sensor may detect if the device is held upright.

Consequently, an orientation sensor may be provided in association with the training device to detect an orientation of the device, to determine the device's position, or determine its orientation relative to a target area. In a further embodiment, a signal output component may be initiated if the detected orientation of the device meets a predetermined orientation. Certain medications may require certain modes of delivery or application, and may dictate the orientation of the device during delivery. The orientation sensor is useful in identifying the proper orientation for the device based on the medicament being administrated or the type of delivery device. For example, with respiratory inhaler devices and training devices, an orientation sensor can detect the angle at which the device is positioned. An orientation sensor may include but is not limited to a multi-axis MEMS gyroscope, in one embodiment, that measures inertia or angular rate. In one embodiment, an orientation sensor can detect if the device is held upright, which is particularly important in a respiratory device in order to receive an accurate dose.

In a further embodiment, the sensor may include a contact sensor provided to detect a contact between the device and the user. In still a further embodiment, the signal output component may be initiated if the detected contact of the device meets a predetermined contact value. The contact sensor may be provided to detect a full or partial contact between the respiratory training device and the user, wherein the signal output component may be initiated if the contact of the respiratory training device meets a predetermined contact value, or in other instances if the contact of the respiratory training device fails to meet the predetermined contact value. For example, a user may be alerted when there is no contact between the device and the user, when there is partial contact between the device and the user or when there is full contact between the device and the user. The contact may refer to contact between the user and a particular portion of the device, for example, the mouth portion of the device in a non-limiting embodiment.

The predetermined contact value may be set at 100% contact between the respiratory training device and the portion of the body of the user being used for the delivery of the medicament (i.e., the mouth), or the contact value may be set between 90-99%, or 80-88% contact such that a user can be made aware when there is sufficient contact between the respiratory training device and the user for adequate positioning for training with the respiratory training device or adequate delivery of medicament from the respiratory training device in non-limiting embodiments. Additionally, or alternatively, in some circumstances contact sensors may be provided on the portion of the respiratory training device which is intended to contact the surface of the user where training for delivery of the medicament is to occur, therefore the contact sensor can alert the user when sufficient contact has been made. The user can also, or alternatively, be alerted by an output from the signal output component when sufficient contact has not been made with the surface of the user via the contact sensor.

Furthermore, one or more contact sensors may be used detect whether an actuation mechanism on the respiratory training device has been activated (i.e. if contact has been made between an actuation member and an actuation member receiving portion of the device to indicate that the actuation member has been compressed so as to activate the device, in one embodiment). Activation of the actuation member of the device may include opening the medicament capsule(s), opening the blister, or providing access to the medicament held within the medicament containing container (or training vesicle) within the device. An output from the signal output component may be provided to the user when the contact sensor has been activated, or in other instances an output from the signal output component may be provided to the user when the contact sensor has not been activated, in a non-limiting embodiment.

In a further embodiment, the fluid flow rate sensor may include an airflow sensor which can detect movement of air through the respiratory training device. The air flow sensor may sense the volume of air through the outlet in a given time. An air flow sensor can indicate when the patient inhales with sufficient force. This helps the patient establish muscle memory around the lungs. As such, it is one of the most important sensors to train a patient to use a dry powder inhaler. Air flow sensors can be implemented using technologies including: a differential pressure sensor (strain gauge) using the Bernoulli principle, and a thermal mass flow sensor, using the thermal transfer principle. The term “fluid” as used herein includes “air”.

An airflow sensor can be used to sense a volume of air as the air moves through the mouth piece portion of the device in a given time, for example. Therefore, the airflow sensor can be used to detect when a user inhales with sufficient force (i.e., the force that would be required to deliver a full dose of the medicament in a medicament-containing medicament delivery respiratory inhaler). Notifying a user when the volume of air inhaled and/or timing of the inhalation is correct and/or incorrect can provide critical training to the user.

In still a further embodiment, an air direction sensor may be used to determine which direction air is flowing through the device, i.e., to or from the user. The air direction sensor can be used to determine whether the user is blowing into the device or inhaling from the device. Because blowing into the device can potentially contaminate the device in some instances, an error condition can be output to the user if the device senses that the air direction has moved from the user to the device. Sensing air direction and airflow may be accomplished with the use of one sensor, in an embodiment, depending on the type of sensor used. In other embodiments, two or more sensors may be used to sense airflow and/or air direction. In one embodiment, a pressure or turbine sensor may be used to detect either one of fluid flow rate or fluid flow direction. In another embodiment, a thermal mass flow sensor may be used to detect both fluid flow rate and fluid flow direction.

The respiratory training device described herein can provide training to a user for any type of respiratory inhaler. While the dry powder inhaler device is specifically focused on herein, the embodiments provided herein are not intended to be limited to use for training for this type of inhaler device only.

The inhaler training device may further include a responsive member to allow a user to select which medicament delivery device the user would like to train him or herself to use with the aid of the respiratory inhaler training device and/or system. This selection may be made by any means known in the art, including but not limited to, by an input of a particular code into the respiratory inhaler training device and/or system which pertains to a specific medicament or medicament delivery device, a barcode scanner associated with the training device used to scan a bar code on the medicament delivery device and/or packaging therefore, for example, or alternatively, in another non-limiting example, the respiratory inhaler training device and/or system may be pre-programmed or use to train a user to use only one or more specific type(s) of respiratory inhaler medicament delivery devices.

The outputs of the device may be provided in many different ways including visually, audibly, by smell, taste, or vibration, by temperature change, or a combination thereof in non-limiting examples. Spoken instructions are easier to follow than written instructions. Spoken instructions can also be processed while a user is handling the training device. As a result, the brain interprets the instructions faster, retains them longer, and retrieves them easier. Each step in the IFU has its own script, and each script is a separate audio file, in one embodiment. An embodiment of the respiratory inhaler training device may have multiple sets of files, each in a different language. The audio technology in an embodiment of the respiratory inhaler training device may include the following characteristics: the bit depth of the audio chip is 16-bit, the audio sampling rate is 16 kHz, maximum bit rate (hardware) is 256 kbps, and available memory size for audio storage is 32 MB, in one particular non-limiting embodiment.

In another embodiment, a respiratory inhaler training system configured to provide instructions for using a respiratory inhaler training device to a user in a sequence of steps is provided. The system may include a respiratory inhaler training device having a housing defining a channel with an inlet and an outlet, the respiratory inhaler training device including an actuation mechanism, said actuation mechanism configured to simulate provision of medicament. The system may further include a respiratory inhaler training container, wherein the training device communicatingly connects to the respiratory inhaler training container. A signal output component may be associated with the respiratory inhaler training container and a microprocessor may be associated with the respiratory inhaler training device or container configured so as to control a provision of the instructions to the user in the sequence of steps.

In a further embodiment, the system may include wherein the respiratory inhaler training container includes a power source. In a further embodiment, the respiratory inhaler training container may communicatingly connect to the respiratory inhaler training device with a wired and/or a wireless connection. The wireless connection may include Bluetooth® technology and/or Radio-Frequency Identification technology (RFID). Information and/or power may be communicated by way of the wired or wireless connection. The communication may include two way or one way communication.

In a further embodiment, a respiratory inhaler training device configured to provide stepwise instructions for using the device to a user in a sequence of steps is provided. The respiratory inhaler training device may include a housing defining a channel with an inlet and an outlet, at least one actuation mechanism for simulating provision of medicament, at least one fluid flow rate sensor positioned so as to detect fluid in the channel, at least one contact sensor disposed between the housing and the actuation mechanism to detect activation and/or deactivation of the actuation mechanism; at least one signal output component for providing an output to the user, and a microprocessor including a timekeeping component, in a non-limiting embodiment, said timekeeping component may be configured to measure elapsed time during and/or between the sequence of steps. The training device may further include a storage medium component associated with the microprocessor comprising a database of instructions pertaining to the sequence of steps for using the device stored thereon, one or more program code modules stored on the microprocessor or the storage medium component or a combination thereof, wherein the one or more program code modules comprise a first program code module for causing the microprocessor to provide a first instruction; and a second program code module for causing the microprocessor to provide a subsequent instruction based on a current register, wherein based on a signal received from the at least one fluid flow rate sensor, at least one contact sensor, and/or at least one orientation sensor, and/or an input received from the user, the microprocessor detects a condition of the device.

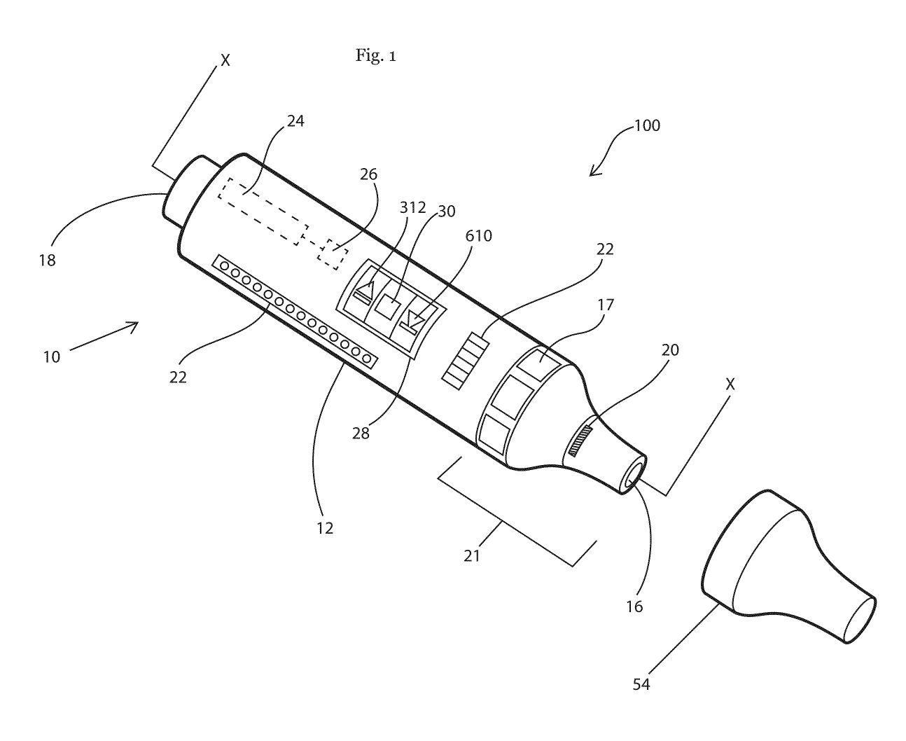

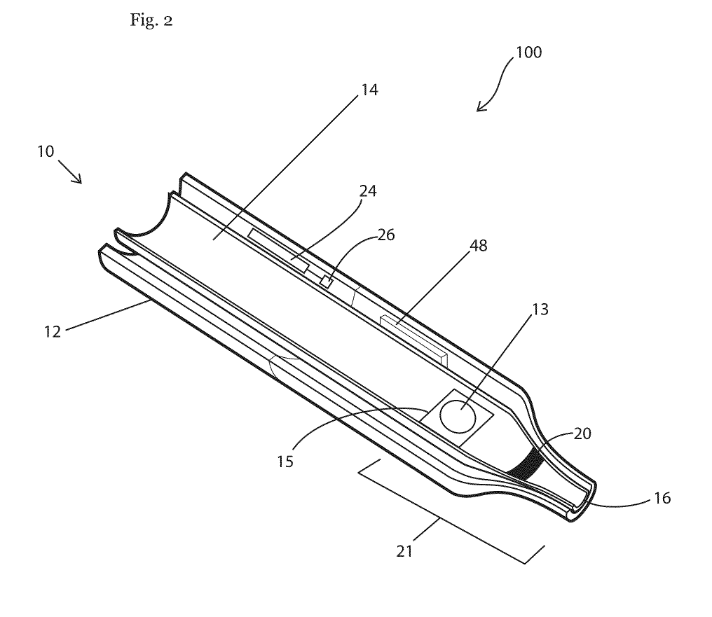

Turning to the Figures, FIG. 1 includes a perspective view of an embodiment 100 of a respiratory inhaler training device 10 configured to provide stepwise instructions for using the device to a user in a sequence of steps, the respiratory inhaler training device 10 including a housing 12 defining a channel 14 with an inlet 17 and an outlet 16. At least one actuation mechanism 18 is in association with the housing 12 for simulating provision of medicament, and at least one fluid flow rate sensor 20 is positioned so as to detect fluid flow rate in said channel 14. A microprocessor 24 may include a timekeeping component, said microprocessor is included in the housing 12 in the embodiment of FIG. 1, and a storage medium component 26 is associated with the microprocessor 24. The storage medium component 26 includes a database of instructions pertaining to the sequence and/or timing of steps for using the device 10 stored thereon. One or more program code modules are stored on the microprocessor 24 or the storage medium component 26, or a combination thereof, wherein the one or more program code modules include a first program code module for causing the microprocessor to provide a first instruction, and a second program code module for causing the microprocessor to provide a subsequent instruction based on a current register. The embodiment 100 of the respiratory inhaler training device shown in FIG. 1 provides a signal output component 22a, 22b and a control interface 28. The control interface includes at least one responsive member 30 (shown as a play button, a stop button and a back button in FIG. 1) reactive to a user input. The responsive member(s) 30 may further include language select, volume up, volume down, on, or off buttons, in non-limiting examples. Furthermore, as described herein, the responsive members need not be embodied as buttons, but may be a display with a digital selection component, or other type of component or member as known in the art to provide selection by a user. In the embodiment 200 of the respiratory inhaler training device 10, a signal output component 22a, 22b of the device 10 is embodied as a speaker to provide audio feedback and instructions to a user.

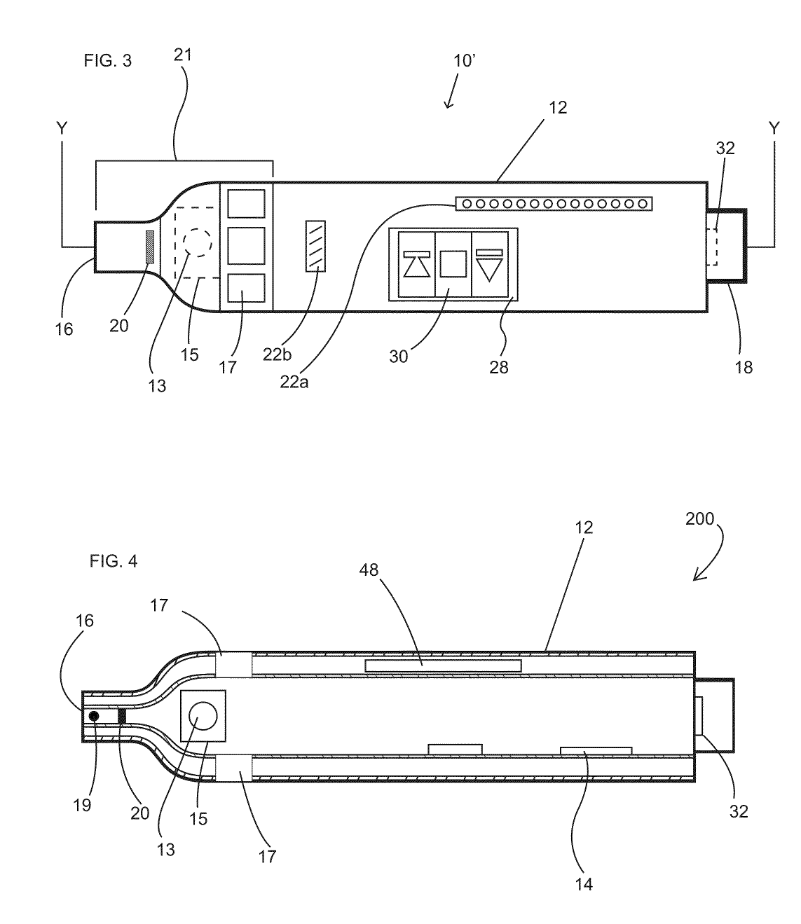

FIG. 2 provides a partial cross-sectional view of the embodiment shown in FIG. 1. FIG. 2 shows an example of a training capsule 13 disposed within the medicament simulation receiving chamber 15 of the housing 12 of the device 10. The training capsule 13 is provided to simulate a dry powder capsule which contain medicament and is used in a dry powder drug delivery inhaler, for example. The outlet 16, fluid flow rate sensor 20, and power source 48 are also shown in the cross-sectional view of FIG. 2. In still another embodiment 200 of the respiratory inhaler training device shown in the side view of FIG. 3, the housing 12 of the respiratory inhaler training device 10′ is shown with a channel 14, an inlet 17 and an outlet 16. The mouthpiece portion 21 of the device 10′ is removable from the rest of the housing 12, allowing access to the medicament simulation receiving chamber 15, wherein a training capsule 13 can be placed there within during use of the device 10′. Two signal output components 22a, 22b, are provided, including a visual indicator 22a, particularly a multi-colored LED array in the example shown, and a speaker to provide audible feedback and/or instructions to a user. Error conditions can be provided to a user of this device by way of visual stimuli with the colored LED array, or by red blinking lights, in non-limiting examples. The LED array may offer visual assistance to guide a patient towards proper force of inhalation, in one non-limiting embodiment which may help establish muscle memory of the lungs. This visual indicator can be provided in addition to (as shown herein) or instead of a speaker or other audio-related signal output component 22b. FIG. 3 also provides a control interface 28 with responsive members 30 as described in reference to FIGS. 1-2.

Furthermore, the actuation mechanism 18 is shown and is embodied as an actuation member (a button in this embodiment), and furthermore, the embodiment 200 of FIG. 3 includes an actuation mechanism sensor 32. The actuation mechanism sensor 32 is disposed between the actuation mechanism 18 and the housing 12. This actuation mechanism sensor 32 may be provided in any other of the embodiments of the device or system described herein. This actuation mechanism sensor 32 is configured to provide an output to the microprocessor 24 when the actuation mechanism 18 has been activated, in one embodiment, or alternatively, inactivated in another embodiment. The embodiments of the device described herein may also include non-volatile memory, piezoelectric buzzers as audible signal output components to notify users of error messages and provide other feedback, as well as LED arrays as visual stimuli. FIG. 4 shows a sensor 19 at or near the outlet 16 of the device. The sensor is provided to detect contact between the outlet 16 of the device and the user. The sensor 19 may include a contact sensor, a proximity sensor, or any other type of sensor known to those skilled in the art.

FIG. 4 provides a partial cross sectional view of FIG. 3, showing the housing 12 with the mouthpiece portion 21, the outlet 16 and the inlets 17 through which air can enter the device 10′. A power source 48 is shown and the sensor 19 is disposed at or near the outlet 16. A fluid flow rate sensor 20 is disposed within the channel 14, and a cross sectional view of the medicament simulation receiving chamber 15 is shown.

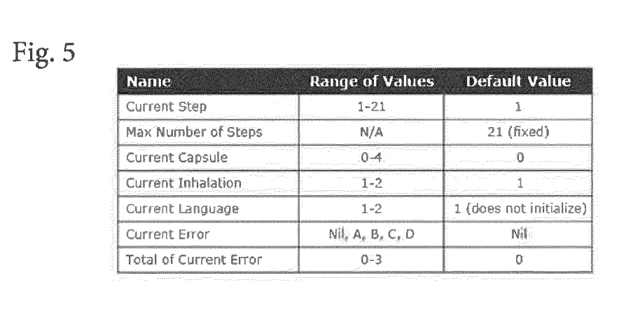

FIG. 5 provides a table including a list of registers of the training device. The registers of the device are temporary values that the algorithm uses to make decisions. The core logic and the subroutines can change the register values. After the user presses the START button, in one embodiment, the register values are set to an initial default value. These registers may be stored in non-volatile memory. The current step register keeps track of the current step of the stepwise instructions. Once the user presses the START button, in this example, the current step is set to 1 (this may also occur upon powering on the device in another non-limiting embodiment). If there is no error condition at this step, the value goes to the next step in a sequence at the end of each cycle. The training device may include any number of steps of instruction which may correlate with the IFU for the medicament delivery device.

The register for the maximum number of steps can be pre-set at the manufacturer, for example. At the end of each step, the algorithm compares the “current step” register to the “max number of steps” register. If the “current step” value is larger, then the program terminates. The current capsule register keeps track of the current capsule or blister in a dry powder inhaler device. In an alternative embodiment, the current capsule register may keep track of the current blister of medicament in the inhaler device. A predetermined number of capsules or blisters may be required for a full dose of medicament. Each capsule may require a predetermined number of inhalations per capsule or blister (i.e., two inhalations, in a non-limiting embodiment) to be emptied and to carry the medicament deep into the lungs of the user. The current inhalation register keeps track of the number of inhalations for each capsule The capsules used in the training device include training capsules which may simulate the medicament containing capsules used with device dry powder inhaler device in appearance, however, the training capsules may not contain medicament. As already described herein, other medicament or non-medicament containing vessels may be used herein, such as, for example, blisters from a blister roll in one non-limiting embodiment.

The current language register represents the language of the spoken instructions. If the user pushes the “language” button, the value toggles between its two options, in one non-limiting embodiment (either 1 or 2). Other embodiments of the device may have additional languages. The “current language” register may not change if the system is turned OFF. If the user activates the START button, this register maintains the value of the last session, in one embodiment. This value may be changed with the language button. If the user makes a mistake, the error subroutine sets the value of the current error register. There are four error conditions, and there are four different values in the non-limiting example provided in the table of FIG. 5. The total current error register keeps track of how often the user repeats the same error while using the device. If the user makes a mistake, and the error subroutine sees that the current error is still the same, then the value of this register is increased by 1, for example. If the user makes the same mistake a predetermined number of times (e.g., three times), the device may play a special message and may turn itself OFF. The special message may include spoken instructions which may include, for example, “You have made this mistake three times in a row, please consult the IFU and/or your healthcare provider before continuing to practice with this device and before using the medicament delivery device.” This predetermined number of times may be pre-set at the manufacturer or alternatively, can be set by the user of the device.

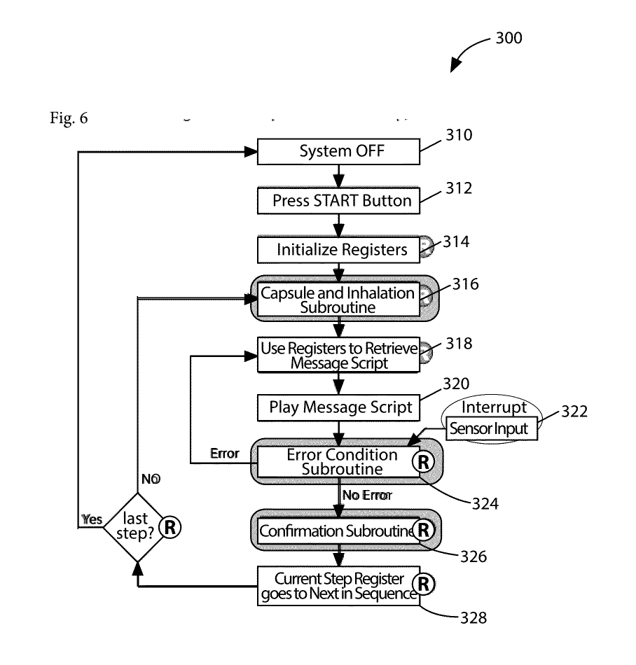

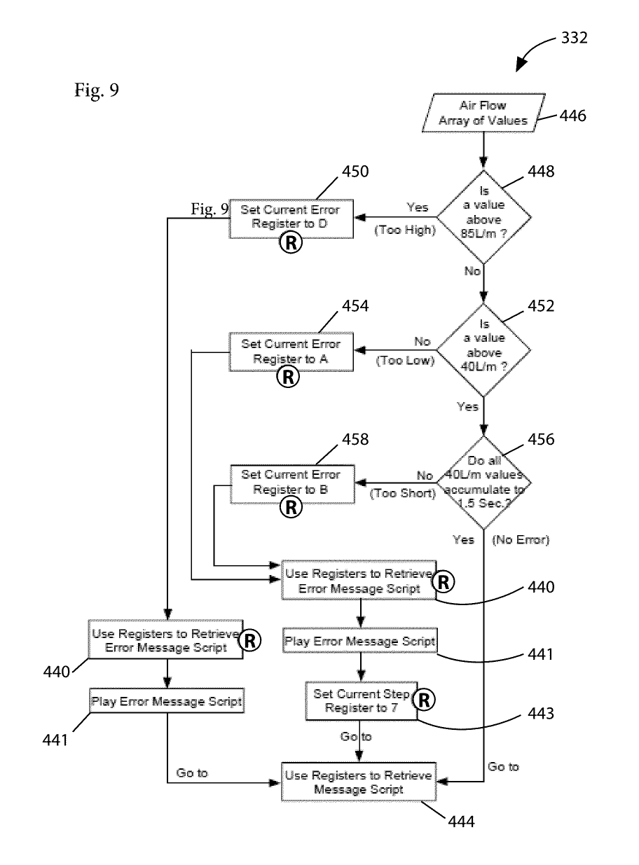

Once the patient inhales, the fluid direction sensor is activated and the fluid flow rate sensor starts sampling values until the values drop below a low, pre-set threshold (e.g. 20 L/m). The fluid flow rate sensor creates an array of values which may be stored in a temporary buffer. This array of values may be evaluated by the Inhalation Error Subroutine (as will be described in more detail in regard to FIG. 9 below). In FIGS. 6-13, the ® symbol indicates that the algorithm either reads from or writes to the register(s).

The logic may include a main algorithm which may include a core logic algorithm 300 and a number of subroutines. The core logic algorithm 300 is provided at least in the flow chart of FIG. 6. Once the start button is initiated 312, the registers are initiated 314. The algorithm 300 sets register values based on events and uses register values to make decisions. The algorithm 300 retrieves message scripts 318 from a lookup table, based on the value of registers. Buttons and sensor inputs, for example, cause interrupts, and these interrupts are described in detail throughout this specification. Once a register is used to retrieve a message script, the message script is played 320. Once the last step in the algorithm 300 is completed, the algorithm may turn itself and the device off 310, in an embodiment.

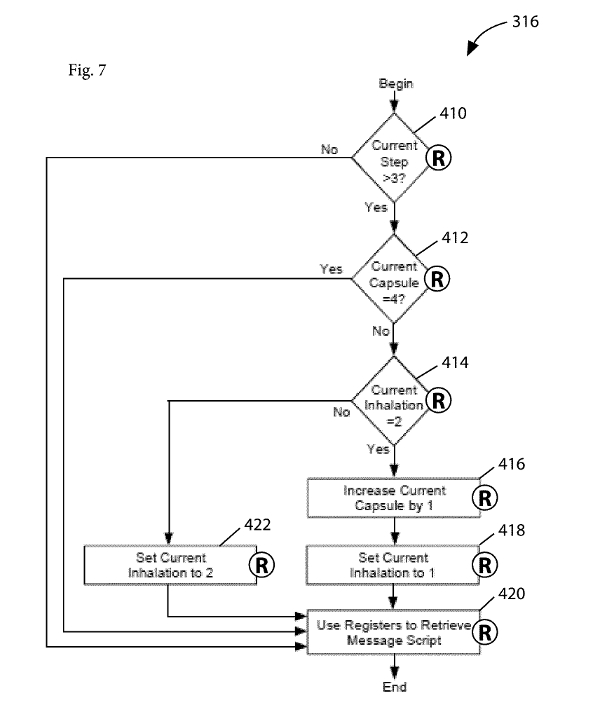

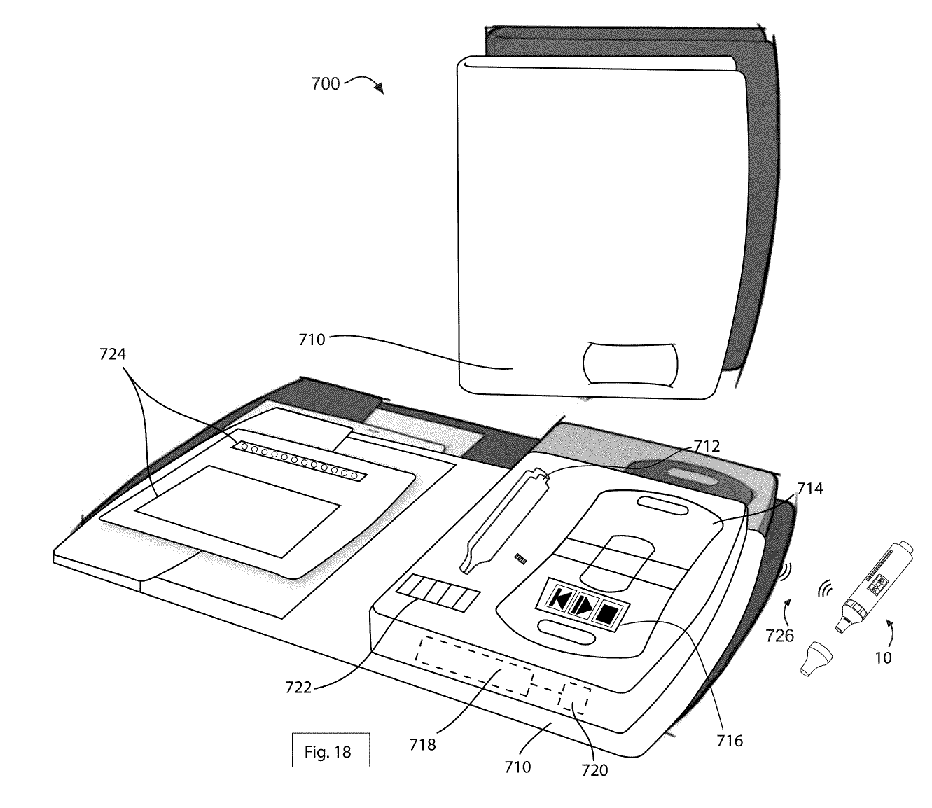

In the training device 10, 10′ which requires four capsules in a non-limiting embodiment, for a dose (two inhalations each) to receive a full dose of medicament, the capsule and inhalation subroutine 316 tracks the full dose requirements (shown in the flow chart of FIG. 7). In other non-limiting embodiments, one or more capsules may be required to receive a full dose, for example. In one embodiment, this capsule and inhalation subroutine 316 uses three registers, in one embodiment. The functions of the capsule and inhalation subroutine 316 include a determination of current step 410, current capsule 412, and current inhalation 414. At each step, either the user moves onto the subsequent step in the determination until the current capsule is increased by 1 at function 416 or registers are used to retrieve a message script 420. Once the current capsule is increased by 1 at function 416, the current inhalation is set to 1 at 418 and the user is instructed to begin the first inhalation with the new capsule. The current capsule cannot be more than 4, in one embodiment. If the current inhalation is 2, the algorithm goes to the next capsule and set the current inhalation to 1; if it is 1, then the current inhalation is set to 2 in function 422 of the capsule and inhalation subroutine 316. At the end of the first capsule the logic plays script 13, at the end of the second capsule, script 14 is played, at the end of the third capsule script 15 is played, and at the end of the last capsule script 16 is played, for example. See FIG. 18 for more details demonstrating the order of instructions provided to a user in an embodiment. Non-limiting examples of instructions for use (including the message scripts which correlate with the numbers mentioned herein) are provided below.

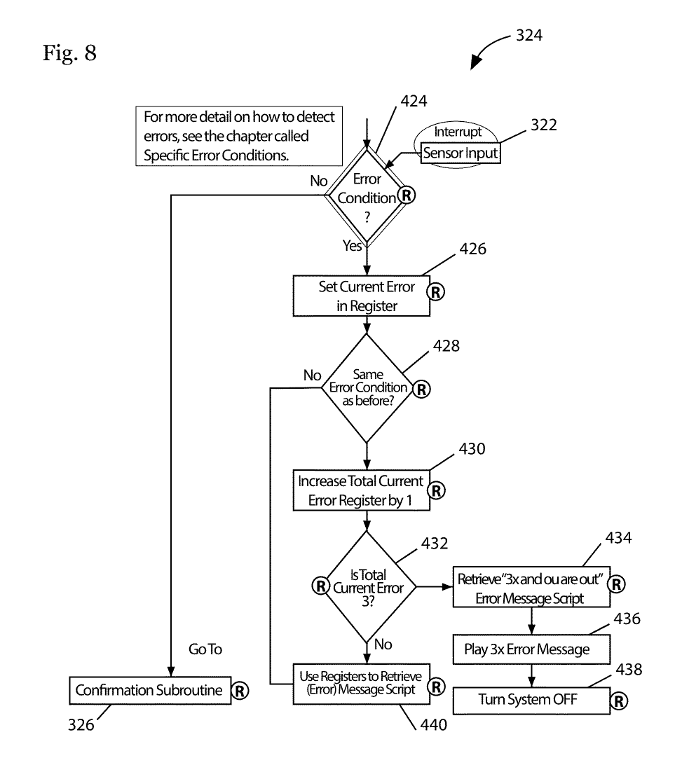

The main algorithm 300 can be interrupted by sensor input 322, which may trigger an error correction subroutine 324 (shown in the flow chart of FIG. 8). This error condition subroutine 324 evaluates if the sensor input represents an error condition, for example. In one embodiment, the error condition subroutine 324 can result in three outcomes: if there is no error condition, the program proceeds to the confirmation subroutine 326, if there is an error condition, and the same error happened a predetermined number of times in a row (i.e., three in a non-limiting embodiment), the device may advise the user to consult the IFU and may then turn itself OFF, in one embodiment. If, for example, there is an error condition (same error did not happen two times before, for example), the subroutine may retrieve an error message from a lookup table based on the value of registers. Each error condition (sensor input, for example) may be detected by a separate subroutine. Each error condition is stored in the device through registers, and each error condition has its own register value, in one embodiment.

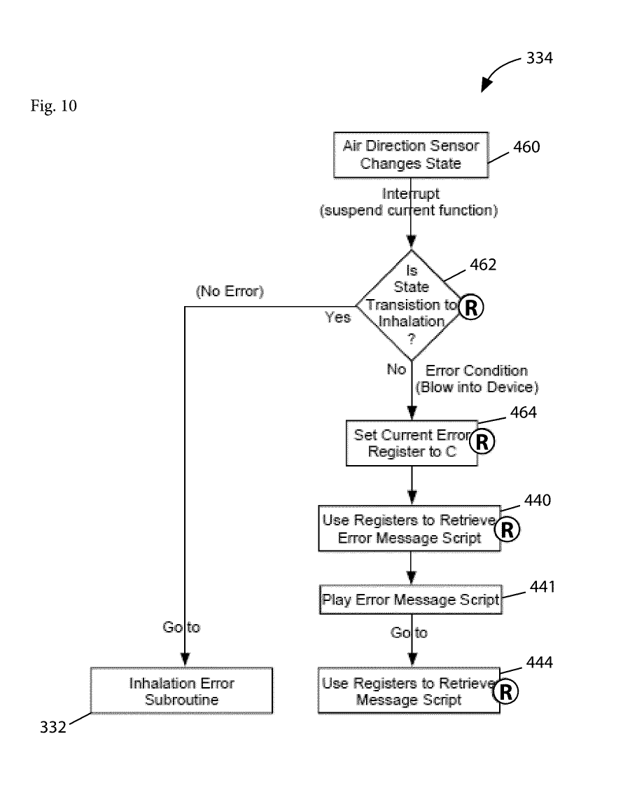

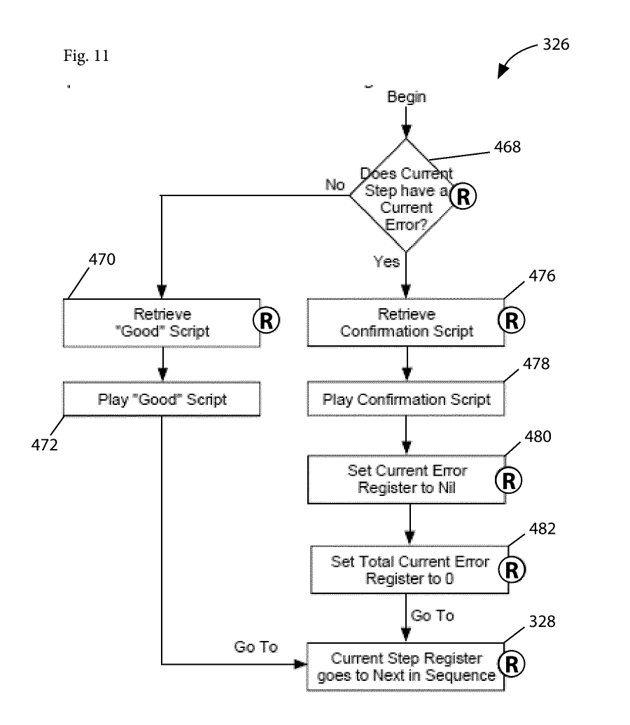

The specific error subroutines include inhalation error subroutine 332 shown in the flow chart of FIG. 9, and the air direction subroutine 334 shown in the flow chart of FIG. 10, and are triggered by the error condition decision 424 in the error condition subroutine 324. In the inhalation error subroutine 332 of FIG. 9, once an inhalation is complete, (air flow falls below 20 L/m, for example)a current step register is set (as shown in the non-limiting example of FIG. 9, as set to 7), this subroutine evaluates the array of air flow values 446 stored in a buffer. By evaluating the values, this single subroutine can detect three error conditions (too low, too high, and too short) by determining if the value stored is above 85 L/m in function 448, if the answer is yes, the rate is too high, an error condition has occurred and the current error register is set (in the non-limiting example of FIG. 9, the current error register is set to D) in function 450, if the answer is no, the subroutine determines if the value is above 40 L/m in decision 452, if the answer is no, the flow rate is too low, an error condition has occurred, and the current error register is set (in the non limiting example of FIG. 9, the current error register is set to A as shown) in function 454. If the answer is yes, the subroutine determines if all values 40 L/m and up accumulate to approximately 1.5 seconds in decision 456, for example. If the answer is no, the air flow value (i.e., the inhalation) was too short, an error condition occurred, and the subroutine continues to function 458 and sets the current error register (as shown in the non-limiting example of FIG. 9, the current error register is set to B), if the answer is yes, no error is identified, and the subroutine goes to function 444, wherein the registers are used to retrieve the message script.

Note that if the inhalation is too low or too short, the logic goes back to function 440, wherein the registers are used to retrieve the error message script, the error message script is played 441, and the current step register is set (in the non-limiting example shown in FIG. 9, the current step register is set to 7) in function 443, where after the registers are used to retrieve the next message script 444. If the inhalation is too high, the logic continues with the next function 444 after the error message script is retrieved with the registers 440, and an error message script is played 441. In a non-limiting embodiment, no current step register may be set if the inhalation is too high.

In the air direction subroutine 334 provided in the flow chart of FIG. 10, this subroutine is triggered by a state transition of the air direction sensor and/or a sensor which detects both airflow rate and air direction 460, in one embodiment. If the user starts to inhale, then the air direction sensor changes state from “no flow” to “inhalation,” in decision 462 for example. If the user starts to exhale, then the air direction sensor changes state from “no flow” to “exhalation” in decision 462. In a non-limiting embodiment, there may not be a register associated with this state transition. An error condition may occur if the patient exhales into the device. If this error condition occurs, the “current error” register may be set (in the non-limiting embodiment shown herein, the current error register is set to C) in function 464.

The flow chart of FIG. 11 provides an embodiment of a Confirmation Subroutine 326, wherein if the error condition subroutine 324 of FIG. 8 decides that the user did not make an error, it proceeds to this confirmation subroutine 326. If, for example, an inhalation is between 40 L/min and 85 L/min, and lasts at least 1.5 seconds, in a non-limiting embodiment, then the device lets the user know that the inhalation was good in function 470. If the user did not make a mistake, two situations may occur: 1) Either the user did not make a mistake the previous time the step was executed (which is determined in decision 468) wherein the current error value does not match this step. Thus, the user inhaled properly, and the device may retrieve the “good script” in function 470, and play a confirmation message that the inhalation was good in function 472. Thereafter, the subroutine goes to “Current Step Register goes to Next in Sequence” function 328 in the core logic algorithm 300, or 2) if the user did make a mistake in the previous attempt at this step in which case, the device may provide a positive reinforcement to the user by retrieving a confirmation script at function 476. After the correct execution of the step, the device will play a message to confirm that the step was completed correctly at function 478, the current error register will be set to nil at function 480, and the total current error register will be set to zero in function 482 if there are no other current errors existing. Thereafter, the logic goes on to the “Current Step Register goes to Next in Sequence” 328 function in the core logic algorithm 300.

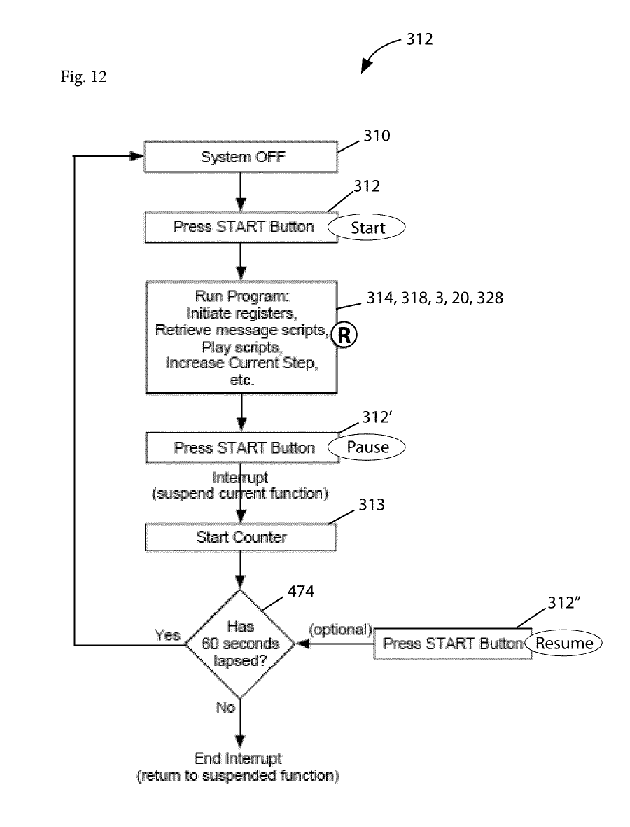

The responsive members provide inputs when selected that trigger simple subroutines which set registers. The subroutine is implemented as an interrupt. In the flow chart embodiment of FIG. 12, the START button subroutine 312 is provided. The start button on the device works as follows: the first time it is pushed, it starts the program and the registers are initialized (314, 318, 320, 328). If the START button is pushed while the program is running it pauses the program 312′, and the registers are not initialized. Once the start button is pressed a second time 312′, the start counter begins 313. If on pause, the user has to push the button again within approximately 60 seconds 474, otherwise the system may turn itself OFF in a non-limiting embodiment. If the user pushes the start button again within 60 seconds 312″, it continues (i.e., resumes) at the point where it paused (interrupted), and all registers are still the same as before the pause.

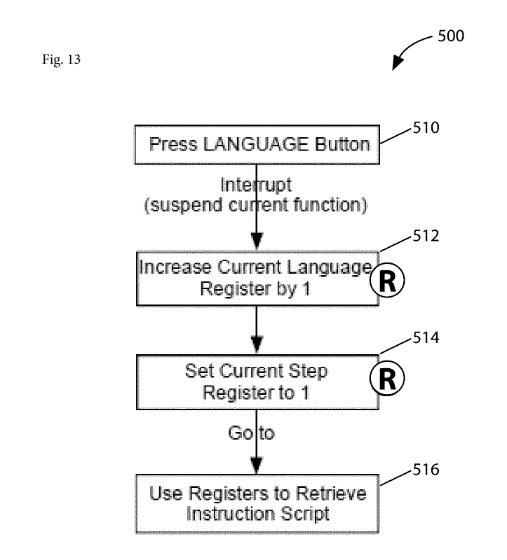

The language button 510 changes the current language register. A flow chart demonstrating the algorithm for the language button 500 is shown in FIG. 13. If there are only two languages, the register toggles. If there are more than two languages, the register is increased by 1 for each different language choice 512, wherein the highest value, it returns to 0. At the end of this interrupt, it does not go to the suspended function (interrupt voided), it ends with a “go to” statement, wherein the registers are used to retrieve the instruction scrip in function 516. If the device is turned OFF, the current language register is not changed when the registers are initialized, the only way to change the current language register is through the LANGUAGE button 510, in the embodiment of the language button algorithm 500 in FIG. 13.

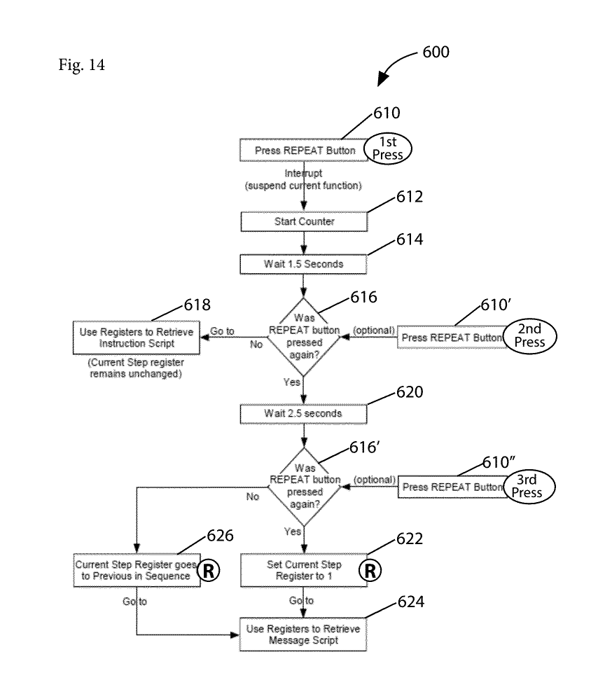

The REPEAT button 610 has multiple functions a shown in the flow chart of the repeat button algorithm 600 FIG. 14. If pressed once 610, it will restart the beginning of the current script 618. The algorithm starts a counter 612 after the initial press of the repeat button 610, after a predetermined amount of time (1.5 seconds) in function 614, the algorithm determines if the repeat button was pressed again in decision 616, of it was not, the current script will be played again 618. If it was pressed twice 610′, after another predetermined time period *(2.5 seconds in the non-limiting embodiment shown in FIG. 14, function 620), the algorithm determines if the repeat button was pressed again in decision 616′. If the repeat button was not pressed a third time, the current step register goes to previous in sequence in function 626. If the repeat button was pressed a third time 610″, the current step register is set to 1, for example, in function 622, and the registers are used to retrieve the message script in 624.

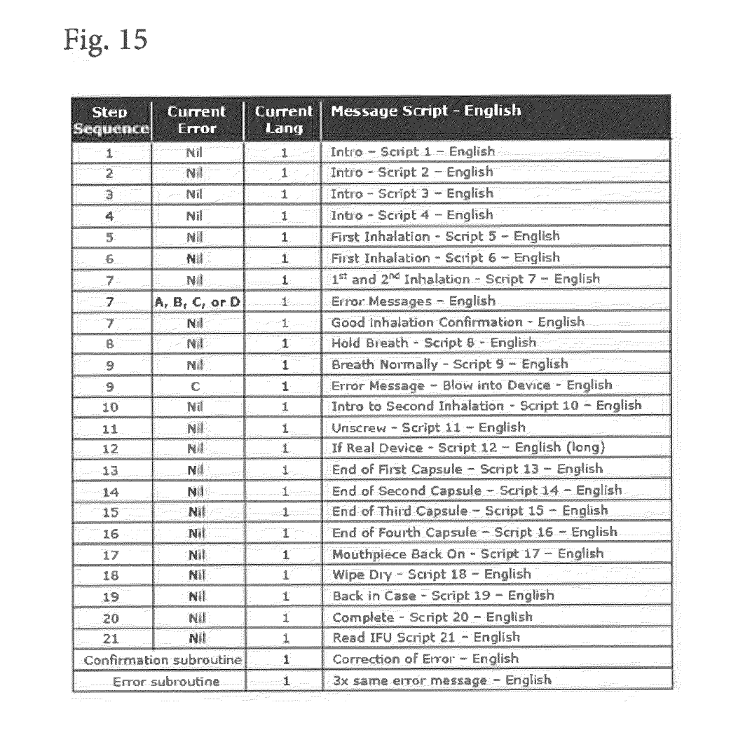

FIG. 15 provides a non-limiting embodiment of an example of a message lookup table. The lookup table is the main data structure of the system, and can be maintained as a separate file. The first three columns are register values, and the fourth column lists message scripts (which may be stored as MP3 files, in one non-limiting embodiment). The registers determine which MP3 file to retrieve and play. The functions and subroutines that retrieve a message script look at the current values of the three registers, and retrieve the corresponding message script. All instructions and error messages are scripts, these scripts may be recorded and compressed in MP3 format, in one non-limiting embodiment. In the embodiment shown herein, button interrupts have priority over sensor input interrupts, and the system turns itself OFF after the last script has been played (if current step>max number of steps), if the user pushed the START button to pause progress of the program and does not push the START button within 60 seconds thereafter, and/or if the user makes the same mistake a predetermined number of sequential times (for example, three consecutive times).

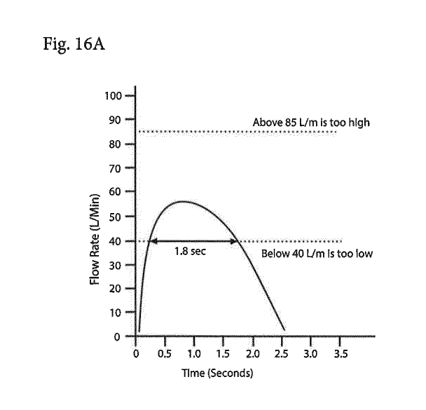

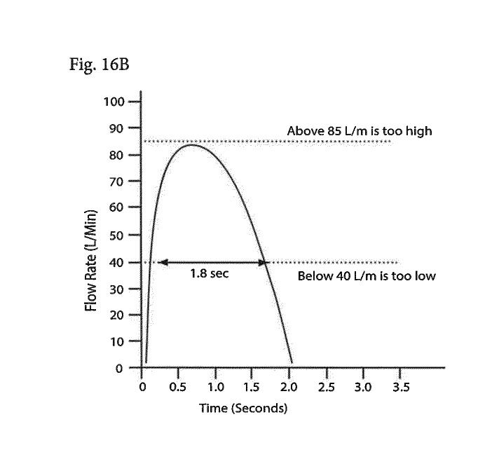

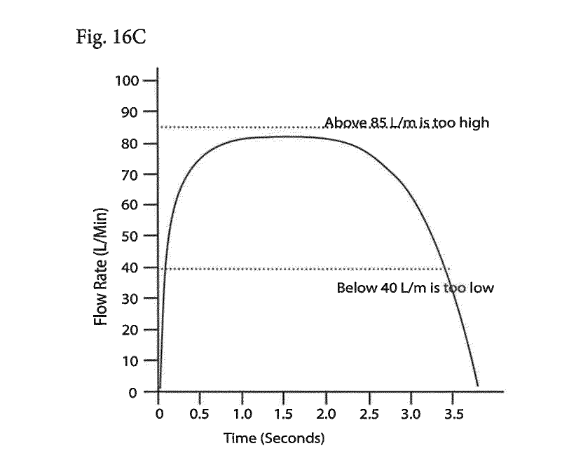

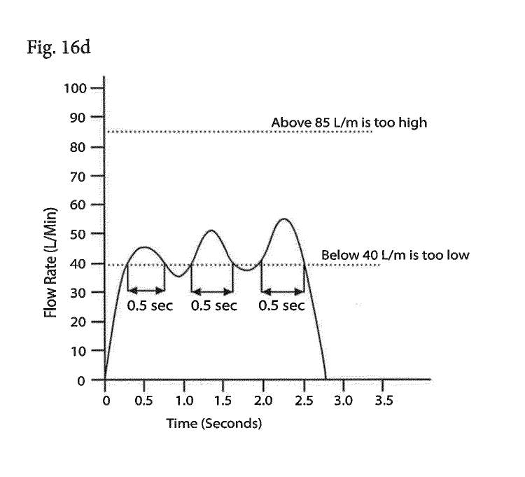

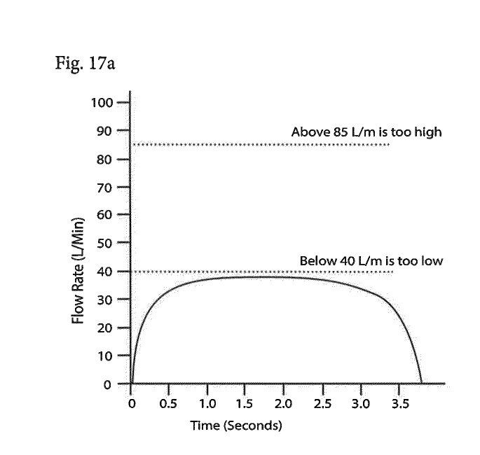

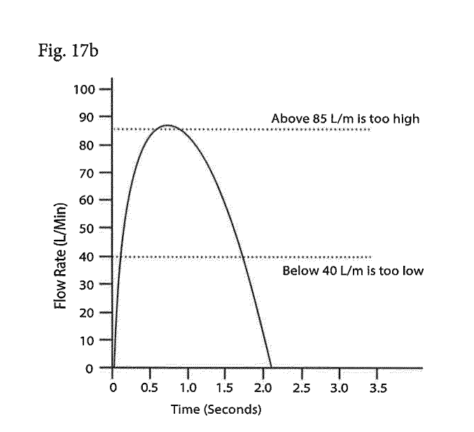

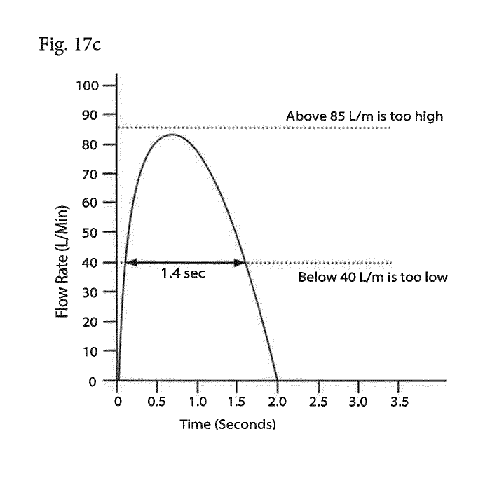

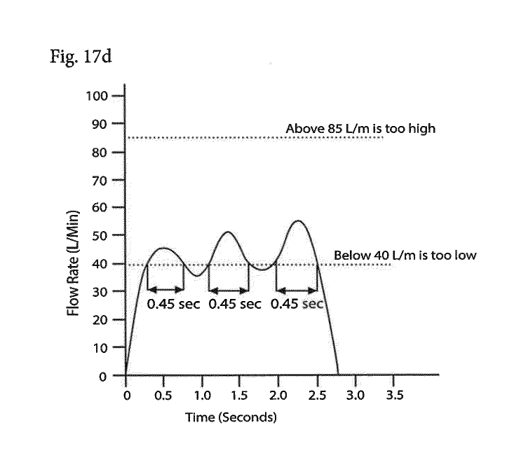

The fluid flow rate sensor samples flow values over time, which may be stored in a temporary buffer. A good inhalation with the device (when the device is used to train for using a dry powder inhaler), is an inhalation that satisfies three criteria: 1) inhalation flow rate above approximately 40 L/m, 2) inhalation flow rate is below approximately 85 L/m, and 3) the accumulated time the inhalation flow rate is above approximately 40 L/m is approximately 1.5 seconds. The graphs shown in FIGS. 16a, 16b and 16c show examples of inhalation flow curves which are “good” according to an embodiment of the device and system herein. FIG. 16d shows a flow rate that fluctuates above and below the 40 L/m threshold. The device and system herein adds together the time that the flow rate was above the 40 L/m threshold, and if the accumulated time is 1.5 seconds or higher, in one embodiment, the inhalation may be considered “good.” The graphs provided in FIGS. 17a-d provide examples of air flow rate sensor inputs that may result in an error condition. FIG. 17a provides an inhalation rate that does not exceed 40 L/m. While the volume of the curve below is about 2 liters (sufficient to empty a capsule or blister), it is an insufficient inhalation rate because it does not meet one of the required criteria (too low). Because the rate never exceeds 40 L/m, it will not deliver the medicament deep into the lungs, which is required for an effective dose of medicament. FIG. 17b shows an inhalation flow rate that goes above 85 L/m and will result in an error condition. If at any time the flow rate exceeds 85 l/m it is too high. FIG. 17c shows an accumulated time above 40 L/m as less than 1.5 seconds, consequently an inhalation flow rate as shown in the graph of FIG. 17c will result in an error condition because it is too short. FIG. 17d shows a graph of an example of an inhalation flow rate that is too short. The inhalation flutters above and below the 40 L/m threshold, wherein less than 1.5 seconds of accumulated time is above the 40 L/m threshold. Consequently, based on the graph of FIG. 17d, this inhalation flow rate would result in an error condition because the time of inhalation above the 40 L/m threshold is too short.

FIG. 18 provides another embodiment 700 of a respiratory inhaler training system configured to provide instructions for using a respiratory inhaler training device to a user in a sequence of steps. The system 700 may include a respiratory inhaler training device 10 having a housing 12 defining a channel with an inlet and an outlet, the respiratory inhaler training device 10 including an actuation mechanism to simulate a provision of medicament. The system 700 further includes a respiratory inhaler training container 710, wherein the training device 10 communicatingly connects to the respiratory inhaler training container 710. The system 700 includes one or more signal output components 724, 722 associated with the respiratory inhaler training container wherein the signal output components may include visual, auditory or other such outputs as described herein. The system 700 also includes a microprocessor 718 associated with the respiratory inhaler training device 10 or container 710 (shown as associated with the container 710 in FIG. 8) configured so as to control a provision of the instructions to the user in the sequence of steps. The container 710 may further include a power source 720 and/or a storage medium component for storing instructions for use and other information thereon.

In a further embodiment of the system 700, the respiratory inhaler training container 710 communicatingly connects to the respiratory inhaler training device 10 with a wired and/or a wireless connection 726. The wireless connection may include Bluetooth® technology and/or Radio-Frequency Identification technology (RFID). The device 10 may be removably received within an opening 712 in the container 710 of the system in an embodiment. The signal output components may include visual outputs 724 which may include, in non-limiting embodiments, an LED display and/or a video or other display. A speaker or other audible output component 722 may be provided. A control interface 714 may be provided including responsive members 716 reactive to user input such as a play, back, and stop button in non-limiting embodiments.

The instruction scripts for the dry powder inhaler respiratory training device are as follows in a non-limiting embodiment:

1. Hello. This Training Device is designed to help you learn how to use your dry powder inhaler training device by walking you through the Instructions for Use.

This training inhaler device is designed to supplement the training you receive from your healthcare provider prior to beginning treatment. It is reusable and contains no medication.

Please make sure that you also refer to the full Patient Information for complete Instructions for Use.

2. Let's get started. (Pause) Follow along using the enclosed training device Visual Aid. (Pause) First you must wash and dry your hands completely. (Pause)

3. Hold the base of the training device and unscrew the lid in a counter-clockwise direction. Set the lid aside on a clean, dry surface. (Pause)

Stand the training Device upright in the base of the case. (Pause)

Hold the body of the Training Device and unscrew the mouthpiece in a counter-clockwise direction. (Pause) Set the mouthpiece aside on a clean, dry surface. (Pause)

4. Now, you can load the Training device.

Take 1 blister card and tear the pre-cut lines along the length. (Pause) Then tear at the pre-cut lines along the width. (Pause)

Peel (by rolling back) the foil that covers 1 practice capsule on the blister card. (Pause)

Only remove 1 practice capsule from the blister card. (Pause) When administering the real capsules, you should only remove one capsule at a time just before you are going to use it in the device. (Pause)

Place the first capsule in the capsule chamber at the top of the Training Device. (Pause) Do not put the capsule directly into the top of the mouthpiece. (Pause)

5. Put the mouthpiece back on your Training Device and screw the mouthpiece in a clockwise direction until it is tight. (Pause) Do not over-tighten the mouthpiece. (Pause)

Hold the Training Device with the mouthpiece pointing down. (Pause) Press the blue button all the way down and let go. (Pause)

Do not press the blue button more than once. The chances of the capsule breaking into pieces will be increased if the capsule is accidentally pierced more than once. (Pause)

6. Now it is time to inhale. You will need to inhale at least twice from each capsule in order to get the full dose. (Pause)

[Steps 7 thru 9 are used for both the first and second inhalation].

7. First, breathe out all the way. Do not blow or exhale into the mouthpiece . (Pause)

Place your mouth over the mouthpiece and close your lips tightly around it. (Pause) As you prepare to inhale, tilt your head back slightly.

Inhale with a single steady deep breath^{A, B, C, D}.

[If there is no error detected:] Great, that was a good inhalation!¹

8. Remove the Training Device from your mouth. Hold your breath for 5 seconds, then exhale normally away from the Training Device^{C}. (Pause)

9. Take a few normal breaths away from the Training Device. Do not blow or exhale into the mouthpiece.^{C}

10. For your second inhalation, repeat the inhalation steps using the same capsule. [Steps 7-9 follow]

11. When you are finished, unscrew the mouthpiece and remove the practice capsule from the capsule chamber.

12. If you were using the real device, you can now check to make sure you have inhaled the powder correctly. You would look at the used capsule to ensure that it is pierced and empty except for a fine coating of powder remaining on the inside of the capsule.

If the real capsule is pierced and empty, you could throw it away. If the real capsule is pierced but still contains more than just a fine coating of powder you would put the capsule back into the Podhaler device capsule chamber with the pierced side of the capsule pointing down. You would then put the mouthpiece back on and inhale deeply one more time.

If the real capsule did not look pierced, you would put the capsule back into the Podhaler device capsule chamber. Put the mouthpiece back, push the blue button and inhale with a single deep breath. Please note that if the capsule does not look pierced and still has some powder in it, you will need to use the reserve Podhaler device provided in the TOBI Podhaler packaging and repeat all of the steps.

13. Congratulations! You have successfully inhaled the first capsule of your dose.

You will need to repeat this procedure 3 more times for your whole dose, which consists of 4 capsules.

Let's repeat again using your second Training capsule.

Place the second capsule in the capsule chamber at the top of the Training Device. (Pause) Do not put the capsule directly into the top of the mouthpiece. (Pause) [Repeat Steps 5 through 12].

14. Great job! You are ready for your third capsule.

Place the third capsule in the capsule chamber at the top of the Training Device. (Pause) Do not put the capsule directly into the top of the mouthpiece. (Pause) [Repeat Steps 5 through 12].

15. You are almost done! You are ready for the last capsule of your dose. Let's repeat these steps a final time.

Place the fourth capsule in the capsule chamber at the top of the Training Device. (Pause) Do not put the capsule directly into the top of the mouthpiece. (Pause) [Repeat Steps 5 through 12].

16. Congratulations! You have successfully completed your first dose. Take the capsule out of the device and throw away all of the used practice capsules. You should not store any capsules in the device.

17. Screw the mouthpiece on to the Training Device. Do not over-tighten the mouthpiece.

18. Wipe the mouthpiece with a clean, dry cloth. Do not wash the device with water. Your device will need to stay dry at all times to work the right way.

19. Place your Training Device back in the storage case base. Place the lid back on the storage case base and screw the cover in a clockwise direction until it is tight.

20. You have completed your practice session. Do not attempt a real inhalation until you have been trained properly by a healthcare professional. If you had problems doing any of these steps, go back and practice again. This Training Device is reusable.

21. Read the accompanying Patient Instructions for Use and the full Prescribing Information before taking your first dose. Additional information about the proper use of the TOBI Podhaler is provided as well as Important Safety Information in the patient brochure.

Error Conditions:

^{A}Not inhaling fast enough (<40 L/m)

^{B}Inhalation is not long enough and will not yield the correct volume

^{C}Patient is blowing into the device

^{D}Inhalaing too fast (>85 L/m)

Error Correction Scripts:

A. Beep or chime You are not inhaling fast enough. Let's try it again. [Repeat steps 7-9].

B. Beep or chime You are not inhaling long enough. Let's try it again. [Repeat steps 7-9].

C. Beep or chime You are blowing into the device. You should be inhaling the medication. Let's try it again. [Repeat steps 7-9].

D. Beep or chime You may experience a cough from inhaling too fast due to the large amount of powder hitting the back of your throat. Slow down with your next inhalation. If you cough, turn your face away from the device. It may help to take a sip of water as well. [Continues to the next step].

Post Correction Scripts:

a) Unfortunately you have made the same error 3 times in a row. Please read the accompanying Patient Instructions for Use prior to starting the Practice Device again from the beginning or seek training assistance from your Healthcare Professional. We will now conclude this training session.

b) Congratulations! You have successfully corrected your error and completed the step correctly. We will now continue on to the next step.

Confirmation Script:

1. Great, that was a good inhalation!

In yet a further embodiment, the respiratory inhaler training system includes a microprocessor, wherein the microprocessor includes a timekeeping component, the microprocessor being configured to receive and process a signal received from said signal receiving component, wherein the microprocessor detects correct and/or incorrect use of the system by a user. In still a further embodiment, the system includes a storage medium component associated with the microprocessor, wherein the microprocessor comprises a database of instructions pertaining to a sequence of steps for using the system, wherein said instructions are provided to a user via the signal output component. The system may be able to detect and provide feedback regarding errors and correct usage of the system based on the output from the system, received by the signal receiving component.

Power Source

The amount of power available to supply the electronics is a challenge as space is often limited in the training devices. This requires including a high amount of energy density in a small space. For the trainer, considerations for viable battery technologies include primary disposable or secondary rechargeable batteries which may be removable and sealable inside the device, in non limiting embodiments.

Powering on the device, in some non-limiting embodiments, may initiate or activate the sequence of instructions from the device or container to the user. However, the instructions may be initiated or activated by any suitable means known in the art. For example, in another embodiment, activation of the actuation mechanism or removal of a protective seal surrounding the device may initiate the sequence of instructions of the device. In yet another embodiment, the sequence of steps of instructions may be initiated by moving the device, which may be recognized via a motion sensor on or associated with the device. In still another embodiment, a user input via the responsive member of the device may power on the device, or activate or initiate the instructions.

As will be appreciated by one of skill in the art, certain examples of the present invention may be embodied as a device or system comprising a processing module, and/or computer program product comprising at least one program code module. Accordingly, the present invention may take the form of an entirely hardware embodiment or an embodiment combining software and hardware aspects, commonly known as firmware. As used herein, firmware comprises a computer program module that is embedded in a hardware device, for example a microprocessor or microcontroller. It can also be provided on flash memory or as a binary image file that can be uploaded onto existing hardware by a user. As its name suggests, firmware is somewhere between hardware and software. Like software, it is a computer program which is executed by a microprocessor or a microcontroller, but it is also tightly linked to a piece of hardware, and has little meaning outside of it in an embodiment.

Certain embodiments of the present invention are described herein with reference to flowchart illustrations and/or block diagrams of methods, devices, systems, and computer program products according to embodiments of the invention. It will be understood that each block of the flowchart illustrations and/or block diagrams, and combinations of blocks in the flowchart illustrations and/or block diagrams, can be implemented by computer-readable program code modules. These program code modules may be provided to a processing module of a general purpose computer, special purpose computer, embedded processor or other programmable data processing apparatus to produce a machine, such that the program code modules, which execute via the processing module of the computer or other programmable data processing apparatus, create means for implementing the functions specified in the flowchart and/or block diagram block or blocks.

Computer program code modules for carrying out the logic or operations of certain embodiments of the present invention may be written in an object oriented, procedural, and/or interpreted programming language including, but not limited to, Java, Smalltalk, Perl, Python, Ruby, Lisp, PHP, “C”, FORTRAN, Assembly, or C++. The program code modules may execute entirely on the device, partly on the device, as a stand-alone software package, partly on the training device and partly on a remote computer or device or entirely on the remote computer or device, the program code modules may execute entirely on the container, or partly on the device and partly on the container. In the latter scenario, the remote computer or device may be connected to the user's device through a local area network (LAN) or a wide area network (WAN), or the connection may be made to an external computer (for example, through the Internet using an Internet Service Provider).

One or more of the program code modules can include a records and statistical analysis feature, and can download and/or transfer records to and from the device. The program code modules may be helpful in research and development of the device. With the use of the program code modules recording and tracking various features and uses of the device, one can readily determine areas in which the device may be improved. The program code modules also include graphing capability of recorded data, as well as data trending results of the performance of the device and/or the user, the efficiency of the user and of the device in training and/or simulation. As part of the program code modules, features such as an output, for example, an alarm or indication (visual, auditory, tactile, or other sensory means) to the user of the device or to another can be initiated if the data received and analyzed by the module is out of range or is trending out of range (a range can be pre-determined).

It should be borne in mind that all patents, patent applications, patent publications, technical publications, scientific publications, and other references referenced herein are hereby incorporated by reference in this application in order to more fully describe the state of the art to which the present invention pertains.

It is important to an understanding of the present invention to note that all technical and scientific terms used herein, unless defined herein, are intended to have the same meaning as commonly understood by one of ordinary skill in the art. The techniques employed herein are also those that are known to one of ordinary skill in the art, unless stated otherwise. For purposes of more clearly facilitating an understanding the invention as disclosed and claimed herein, the following definitions are provided.

While a number of embodiments of the present invention have been shown and described herein in the present context, such embodiments are provided by way of example only, and not of limitation. Numerous variations, changes and substitutions will occur to those of skill in the art without materially departing from the invention herein. For example, the present invention need not be limited to best mode disclosed herein, since other applications can equally benefit from the teachings of the present invention. Also, in the claims, means-plus-function and step-plus-function clauses are intended to cover the structures and acts, respectively, described herein as performing the recited function and not only structural equivalents or act equivalents, but also equivalent structures or equivalent acts, respectively. Accordingly, all such modifications are intended to be included within the scope of this invention as defined in the following claims, in accordance with relevant law as to their interpretation.

While one or more embodiments of the present invention have been shown and described herein, such embodiments are provided by way of example only. Variations, changes and substitutions may be made without departing from the invention herein. Accordingly, it is intended that the invention be limited only by the spirit and scope of the appended claims. The teachings of all references cited herein are incorporated in their entirety to the extent not inconsistent with the teachings herein.

What is claimed is:

1. A respiratory inhaler training device configured to provide stepwise instructions for using the device to a user in a sequence of steps, the respiratory inhaler training device comprising:
a housing defining a channel with an inlet and an outlet;
at least one actuation mechanism simulating provision of medicament;
at least one fluid flow rate sensor positioned so as to detect fluid flow rate in said channel;
a signal output component for providing an output;
a microprocessor comprising a timekeeping component;
a storage medium component associated with the microprocessor comprising a database of instructions pertaining to the sequence and/or timing of steps for using the device stored thereon;
one or more program code modules stored on the microprocessor or the storage medium component, or a combination thereof, wherein the one or more program code modules comprise
a first program code module for causing the microprocessor to provide a first instruction; and
a second program code module for causing the microprocessor to provide a subsequent instruction based on a current register; and optionally, further comprising a power source.

2. The respiratory inhaler training device of claim 1, wherein the at least one fluid flow rate sensor is configured to detect a rate of fluid flow through the channel to determine a fluid flow rate.

3. The respiratory inhaler training device of claim 2, wherein a third program code module causes the microprocessor to compare one or more fluid flow rate values detected with one or more predetermined fluid flow rate values, wherein when the detected fluid flow rate values do not meet the predetermined fluid flow rate values, an error condition is set in the current register, and a signal output component is initiated to provide an error message to the user.

4. The respiratory inhaler training device of claim 3, further comprising a fourth program code module, said fourth program code module causes the microprocessor to measure the one or more fluid flow rate values over an elapsed time period, such that an error condition is set in the current register and a signal output component is initiated to provide an output to the user if the elapsed time period detected is less than a predetermined time period value.

5. The respiratory inhaler training device of claim 1, further comprising at least one contact sensor.

6. The respiratory inhaler training device of claim 5, wherein the at least one contact sensor comprises an actuation sensor, said actuation sensor is disposed between the housing and the actuation mechanism said actuation sensor configured to provide a signal to the microprocessor when the actuation mechanism has been activated and/or inactivated.

7. The respiratory inhaler training device of claim 1, wherein the current register comprises information about a current step number, a current error condition and/or a current language.

8. The respiratory inhaler training device of claim 7, wherein the current step number is based on the sequence of steps, user input, and/or sensor input.

9. The respiratory inhaler training device of claim 8, wherein the device further comprises at least one responsive member reactive to user input, and wherein the user input comprises a selection to return to a previous instruction, pause the stepwise instructions, move forward to the next instruction, power on or off the device, set a different language, play the instruction script, and/or adjust the audio volume of the device.

10. The respiratory inhaler training device of claim 1, wherein the current register comprises information about a current step number and a current error condition.

11. The respiratory inhaler training device of claim 1, wherein based on an input received from the fluid flow rate sensor, the microprocessor detects whether an error condition has occurred, wherein when an error condition occurs, the microprocessor sets a current error in the current register.

12. The respiratory inhaler training device of claim 1, wherein following a current error set in the current register, correct completion of the step in which the error condition previously occurred removes the current error in the current register and resets the current register to zero.

13. The respiratory inhaler training device of claim 11, wherein when an error condition occurs, the subsequent instruction comprises a corrective instruction.

14. The respiratory inhaler training device of claim 11, wherein when an error condition has occurred, an error message is output to the user.

15. The respiratory inhaler training device of claim 1, wherein the signal output component comprises one or more speakers, and wherein error messages, confirmation messages, and/or corrective instructions are provided to the user by way of an audio output.

16. The respiratory inhaler training device of claim 1, wherein the signal output component comprises at least one or more visual stimuli such that the instructions are provided to the user by way of a visual output.

17. The respiratory inhaler training device of claim 1, wherein when a last instruction of the sequence of steps is executed, the device is powered off.

18. The respiratory inhaler training device of claim 1, wherein when an error condition occurs in a step in which the same error condition previously occurred a predetermined number of times, the device is powered off.

19. (canceled)

20. (canceled)

21. The respiratory inhaler training device of claim 1, wherein an error condition in the use of the device is detected based on the fluid flow rate sensor and/or a condition of the device relative to at least one predetermined value for the fluid flow rate sensor and/or the condition of the device as stored on the storage medium component.

22. The respiratory inhaler training device of claim 1, wherein a sixth program code module causes the microprocessor compare a condition of the device with at least one predetermined value for the condition of the device stored on the storage medium component.

23. The respiratory inhaler training device of claim 1, further comprising a control interface associated with the device, the control interface comprising at least one responsive member reactive to user input; wherein, optionally, the at least one responsive member is configured to receive input to set a current language of the device upon selection, return to a previous instruction in the sequence of steps upon selection, and/or pause the instructions upon selection.

24. (canceled)

25. The respiratory inhaler training device of claim 1, wherein the device is configured to power off after a pre-set time period.

26. The respiratory inhaler training device of claim 1, wherein when no error condition is detected at an instruction of the sequence of steps, the current step number increases by one.

27. The respiratory inhaler training device of claim 1, wherein when the user correctly uses the device according to the instruction in the sequence of steps at which an error condition previously occurred, a seventh program code module causes the microprocessor to execute a confirmation message to the user; and, optionally, wherein when the user correctly uses the device according to the instruction at a step in the sequence of steps, an eighth program code module causes the microprocessor to execute a confirmation message to the user that the step was performed correctly.

28. (canceled)

29. (canceled)

30. The respiratory inhaler training device of claim 3, wherein the one or more predetermined fluid flow rate values comprise values between 45 L/min and 85 L/min.

31. The respiratory inhaler training device of claim 1, wherein the device further comprises a fluid direction sensor, said fluid direction sensor configured to detect the direction of the flow of a fluid in said channel; and optionally, further comprising a fifth program code module, said fifth program code module causes the microprocessor to compare a fluid direction value detected with the fluid direction sensor with a predetermined fluid direction value as stored on the storage medium, wherein said signal output component is initiated if the detected fluid direction value does not meet the predetermined fluid direction value, and/or a current error condition is set in the current register.

32. (canceled)

33. (canceled)

34. (canceled)

35.-59. (canceled)
